(19) United States
(12) Patent Application Publication
(10) Pub. No.: US 2007/0004435 A1
(43) Pub. Date: Jan. 4, 2007

(54) System and method for permitting maintenance of privacy of main number assigned to wireless device

(76) Inventors: Christopher Brian Dwyer, Fort Myers, FL (US); Carl Dean Wilber, Sulton, WA (US); Steve Zitnik, Fort Myers, FL (US); Michael Debrecini, Fort Myers, FL (US); John Dwyer, Fort Myers, FL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/516,312

(22) Filed: Sep. 6, 2006

Related U.S. Application Data
(63) Continuation of application No. 11/222,542, filed on Sep. 9, 2005, now abandoned.
Application No. 11/222,542 is a continuation of application No. 09/780,946, filed on Feb. 9, 2001, now abandoned.
Application No. 09/780,946 is a continuation-in-part of application No. 09/658,001, filed on Sep. 8, 2000, now Pat. No. 6,687,508.

(51) Int. Cl. H04Q 7/20

(52) U.S. Cl. 455/466

(57) ABSTRACT

A wireless communications system is depicted in which a message can be delivered to a wireless device. In the communications system, a first number included within a true address for communication with the device is associated with the device. A second number distinct from the first number is also associated with the device. A communication is received that includes a phantom address, at least a portion of which includes the second number, and a message. The true address is derived by at least deriving the first number from the second number. The message can then be delivered to the device based upon the derived true address.

### CROSS-REFERENCE TO RELATED APPLICATIONS

This application is a continuation of U.S. Ser. No. 11/222,542, filed Sep. 9, 2006, which is a continuation of U.S. Ser. No. 09/780,946, filed Feb. 9, 2001, which is a continuation-in-part of U.S. Ser. No. 09/658,001, filed Sep. 8, 2000, entitled “System and Method for Providing Numeric-Only Paging Service with Wireless Telephone Service.” The full disclosure of U.S. Ser. No. 11/222,542 is hereby incorporated by reference. The full disclosure of U.S. Ser. No. 09/780,946 is hereby incorporated herein by reference. The full disclosure of U.S. Ser. No. 09/658,0001 is hereby incorporated herein by reference.

### FIELD OF THE INVENTION

The present invention is directed generally to services for wireless technology, and more particularly, to maintenance of the privacy of a telephone number and/or pager number assigned to a wireless subscriber.

### BACKGROUND OF THE INVENTION

With the advent of wireless digital telephones, new features have become available for wireless cellular telephone users. One of the features developed is short message service (SMS), which is commonly available from carriers that provide digital wireless service. With this technology, digital wireless carriers can provide an additional means of communication for their subscribers, typically at no additional charge. In particular, digital wireless carriers permit their subscribers to send and receive short text messages (up to one hundred sixty alphanumeric characters) to and from a variety of sources, including paging terminals and even the Internet. Digital wireless telephones have the ability to send and receive such messages. It will be appreciated, however, that such messages are not derived from the dual-tone, multi-frequency (DTMF) signals generated by pressing respective ones of the keys on a conventional telephone keypad. Rather, short text message signals are alphanumeric in nature and are generated by keyboards of computer terminals and similar devices. When sending an SMS message via a telephone, the telephone keypad is used as a keyboard to generate the desired alphanumeric message.

In light of the foregoing, it will be understood that alphanumeric and SMS paging technologies have been implemented for use with digital wireless telephone technology. Traditional alphanumeric pagers have been replaced by digital telephones, which have the capability to function both as a telephone and as a paging receiver able to send and receive alphanumeric and/or SMS pages. As a result, only one device—the digital telephone—is needed. Prior to the integration of this technology, a cellular telephone was needed for telephone communication and a pager was needed for alphanumeric text messaging.

One drawback of the digital wireless/SMS integrated technology is that it has not met the need to implement traditional, numeric-only paging service with wireless telephone service. As will be appreciated by those skilled in the art, traditional, numeric-only paging service uses the DTMF signals generated by pressing respective ones of the keys on a conventional telephone keypad to derive a numeric-only page, which identifies a callback telephone number when received by a paging receiver. Because this technology has not been developed, digital wireless subscribers could not be paged by telephones.

Another drawback of wireless telephone technology is that there has never been a paging technology implemented therewith permitting the wireless telephone subscriber to maintain the privacy of his/her wireless telephone number. Similarly, there has never been an alphanumeric paging technology that permits a paging subscriber to maintain the privacy of the pager number assigned to his/her paging device. As will be appreciated, the need to maintain the privacy of a wireless telephone subscriber's wireless telephone number to minimize costs for use of the telephone is of prime concern. Use of wireless telephones is expensive, and it is believed that costs associated therewith will continue to grow as demand for such use increases over the next few decades. By failing to maintain the privacy of a wireless telephone subscriber's wireless telephone number, the subscriber can be subjected to unnecessary use, which translates into unnecessary, undesirable costs.

Similarly, another drawback of wireless telephone technology is that there has never been the implementation of alphanumeric messaging service that permits the wireless telephone subscriber to maintain the privacy of his wireless telephone number and/or permits the alphanumeric paging subscriber to maintain the privacy of his/her pager number.

In light of the foregoing, it is desirable to implement traditional, numeric-only paging technology with wireless telephone technology.

It is further desirable to implement traditional, numeric-only paging technology with digital wireless telephone technology.

It is still further desirable to develop an implementation of traditional, numeric-only paging technology for use with wireless telephone technology that maintains the privacy of a wireless telephone subscriber's wireless telephone number.

It is still further desirable to develop an implementation of alphanumeric messaging technology for use with wireless telephone technology that maintains the privacy of a wireless telephone subscriber's wireless telephone number.

It is yet further desirable to develop alphanumeric paging technology that maintains the privacy of a paging subscriber's pager number.

These and other objects are met by various aspects and forms of the present invention. These and other objects will become apparent from the following description. It will be understood, however, that an apparatus or system could still appropriate the claimed invention without accomplishing each and every one of these objects, including those gleaned from the following description. The appended claims, not the objects, define the subject matter of the invention. Any and all objects are derived from the preferred forms of the invention, not the invention in general.

### SUMMARY OF THE INVENTION

The present invention is directed to a method of delivering a message to a wireless device. The method includes the step of associating a first number with the device. The first number is included within a true address for communication with the device. The method also includes the step of associating a second number with the device. The second number is distinct from the first number and is not included within the true address. The method further includes the step of receiving a communication that includes a phantom address and a message. At least a portion of the phantom address includes the second number. Still further, the method includes the step of deriving the true address by at least deriving the first number from the second number. Even further, the method includes the step of delivering the message to the device based upon the derived true address.

The present invention is also directed to a system for providing numeric-only paging service to wireless telephone service. The system includes a dual-tone, multi-frequency-to-short message service converter unit configured to receive dual-tone, multi-frequency signals and convert the signals into a short message service text message. The system also includes a short message service server coupled in communication with the converter unit. The short message service server is adapted to receive the short message service text message and transmit a page to a mobile telephone switching office for ultimate transmission of the short message service text message to a wireless telephone. In a preferred embodiment, the DTMF-to-SMS converter unit is a voice mail system.

The present invention is also directed to a method of providing numeric-only paging service for wireless telephone service. The method includes the step of receiving a plurality of dual-tone, multi-frequency signals from a telephone. It also includes the step of converting the plurality of dual-tone, multi-frequency signals into a short message service text message. The method further includes the step of transmitting the short message service text message to a short message service server. It still further includes the step of transmitting a page to a mobile telephone switching office to initiate ultimate transmission of the short message service text message to a wireless telephone, in response to receipt of the short message service text message by the short message service server.

The method of the present invention is also directed to the step of assigning an auxiliary telephone number to a wireless telephone. The auxiliary telephone number is distinct from a main telephone number assigned to said wireless telephone which activates calls for the wireless telephone. The method further includes the step of receiving a telephone call from a telephone in response to dialing of the auxiliary telephone number. It still further includes the step of receiving a plurality of dual-tone, multi-frequency signals from the telephone. Still yet further, the method includes the step of converting the plurality of dual-tone, multi-frequency signals into a short message service text message. Moreover, it includes the step of transmitting the short message service text message to a short message service server. Additionally, it includes the step of transmitting a page to a mobile telephone switching office to initiate ultimate transmission of the short message service text message to the wireless telephone in response to receipt of the short message service text message by the short message service server.

Another method of the present invention is also directed to the step of assigning an auxiliary telephone number to a wireless telephone. Again, the auxiliary telephone number is distinct from a main telephone number assigned to the wireless telephone which activates calls for the wireless telephone. The method further includes the step of receiving an alphanumeric message at an address associated with the auxiliary telephone number. The method further includes the step of translating the auxiliary telephone number into the main telephone number assigned to the wireless telephone and thereafter permits transmission of a short message service text message to the wireless telephone.

### BRIEF DESCRIPTION OF THE DRAWING

In describing the preferred forms of the present invention, reference is made to the accompanying drawing, wherein:

FIG. 1 is a diagrammatic view of a numeric-only paging system for use in conjunction with wireless telephone service;

FIG. 2 is a diagrammatic view of a communications system utilizing the privacy features of the present invention for use in conjunction with wireless telephone service and pager service;

FIG. 3 is a diagrammatic view of part of a communications system utilizing the privacy features of the present invention for use in conjunction with wireless telephone service and pager service; and

FIG. 4 is a diagrammatic view of another part of the communications system depicted in part in FIG. 3.

### DETAILED DESCRIPTION OF THE PREFERRED EMBODIMENTS

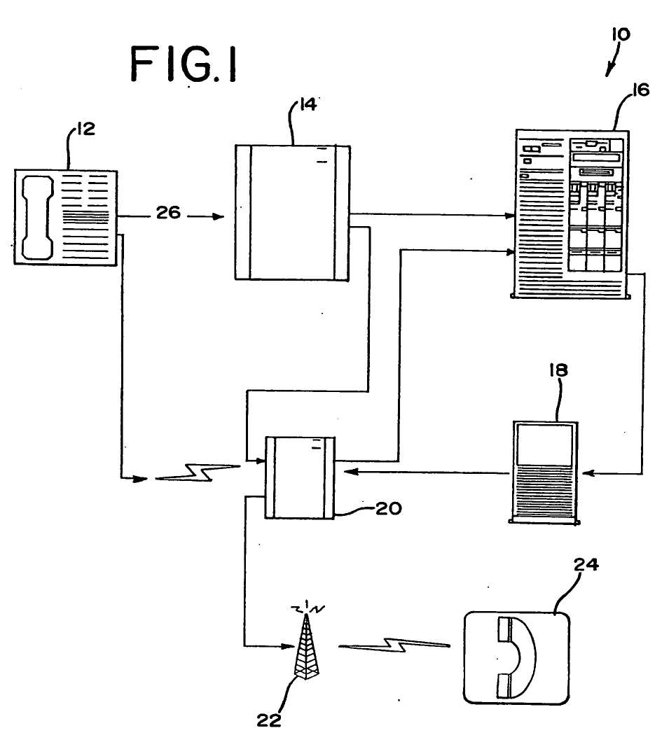

FIG. 1 illustrates a communications system 10 depicted in U.S. Ser. No. 09/658,001, filed Sep. 8, 2000, entitled “System and Method for Providing Numeric-Only Paging Service With Wireless Telephone Service,” the full disclosure of which is hereby incorporated herein by reference. In. FIG. 1, communications system 10 provides traditional, numeric-only paging service to subscribers of digital wireless telephone service. Communications system 10 includes a telephone 12 shown illustratively as a landline telephone. It will be appreciated, however, that telephone 12 could alternatively be a wireless telephone. Communications system 10 further includes a landline telephone company switch 14, which is conventionally located at a central office of a telephone service provider.

Communications system 10 also includes a voice mail system 16 and a short message service (SMS) server 18 for providing the numeric-only paging service. A mobile telephone switching office (MTSO) 20, a cell site 22 and a digital wireless telephone 24 are also included for providing digital wireless telephone service. As will be appreciated, FIG. 1 illustrates relatively minimal hardware components for system 10. In practice, a plurality of each of these hardware components will ordinarily be used.

In accordance with the present invention, each digital wireless telephone subscriber receiving the numeric-only paging service will be assigned at least two telephone numbers. The main telephone number assigned to the subscriber will correspond to normal call delivery. When the main number is dialed, the subscriber's wireless telephone will ring and permit normal call delivery. The subscriber's wireless service provider will assign this main telephone number. The auxiliary telephone number assigned to the subscriber will correspond with the numeric-only paging service. This auxiliary telephone number will be assigned by the wireless service provider, or, alternatively, could be assigned by another numeric-only paging service provider. Use of this auxiliary telephone number allows the wireless telephone subscriber to maintain the privacy of his/her main wireless telephone number so that use of wireless telephone airtime is most efficient.

Reference will now be made to FIG. 1 to describe the functionality of the numeric-only paging service. First, a telephone user initiates a telephone call at telephone 12. As will be appreciated, this telephone call is initiated when the telephone user at telephone 12 desires to have a digital wireless telephone subscriber using digital wireless telephone 24 to place a return call. The call at telephone 12 is initiated by lifting its associated handset and pressing appropriate keys on its associated keypad corresponding with the auxiliary telephone number assigned to the digital wireless telephone subscriber. In the case where telephone 12 represents a landline telephone, the call is then routed through a plain ordinary telephone service (POTS) line 26 to landline telephone company switch 14, from which it is forwarded to voice mail system 16 directly or through MTSO 20, as shown. In the case where telephone 12 represents a wireless telephone, the call is routed to MTSO 20 and then forwarded to voice mail system 16.

Voice mail system 16 is preferably specially configured to provide numeric-only paging service. Voice mail system 16 preferably emulates a paging terminal call and prompts the telephone user at telephone 12 to enter a “callback” telephone number. Preferably, voice mail system 16 offers no options for leaving voice message. Further details regarding a preferred class of service for voice mail system 16 are set forth below.

In response to the prompt, the telephone user at telephone 12 will press telephone keys indicative of the “callback” number. As a result, a DTMF signal will be generated for each pressed key. Voice mail system 16 receives each DTMF signal, converts it to text corresponding with the number associated therewith and delivers the text message to SMS server 18 for transmission to the digital wireless telephone. Voice mail system 16 also translates the auxiliary number into the main telephone number to permit proper transmission of the numeric page.

As will be appreciated by those skilled in the art, voice mail platforms, such as voice mail system 16 illustrated in the drawing, are typically configured to connect to SMS servers, such as SMS server 18 illustrated in the drawing. The connections vary, but are ordinarily either direct links or dial-up connections. As will be appreciated, a direct link connection is preferred, and such connection is preferably used for communications system 10.

It will also be appreciated that a variety of paging protocols can be provided by voice mail system 16, including TAP, SMPP, SNPP, TNPP and DTMF. In its preferred form, the SMS server 18 of communications system 10 can support all of these protocols. Once the voice mail system 16 processes the message, it delivers an emulated text message to SMS server 18, which will function normally provided any of the supported protocols are being used.

The SMS server 18 then transmits a paging signal to MTSO 20 for message delivery. The SMS server 18 is preferably connected to MTSO 20 through either a dial-up connection or a serial link. Once paged, MTSO 20 locates the digital subscriber based upon the nearest cell site 22 to digital wireless telephone 24, and thereafter delivers the numeric-only page indicative of the “callback” number.

This numeric-only paging service for wireless telephony eliminates the need for obtaining, maintaining and insuring two wireless hardware devices by the wireless subscriber. It provides traditional numeric-only paging service directly to the subscriber's wireless telephone, and it permits the subscriber to maintain the privacy of the main telephone number associated with the wireless telephone. In particular, it requires that only the auxiliary pager number be dialed in order to transmit a numeric-only page to the digital wireless subscriber.

The preferred voice mail platform for the present invention is now described. As background, those skilled in the art will appreciate that voice mail platform mailbox types are generally defined by their class of service. The class of service for a particular mailbox type normally defines fields such as message length, greeting length, and number of messages. Additionally, a mailbox can be configured to deliver an SMS message to a subscriber's wireless telephone, or dial out to a pager for notification of a new voice message. In most cases, the platform vendor creates various classes of service at the time of installation, or as needed. Ordinarily, a new class of service can be created, as desired. Several different platforms are available for use. With the present invention, it is contemplated that the vendor will preferably be contacted to assist with the creation of a preferred new class of service. This new class of service will preferably have the following characteristics.

A first characteristic of this new class of service is that it will preferably provide for a standard generic attendant greeting that offers the caller only one option, namely entry of the “callback” number. The greeting might state, for instance, “please enter a telephone number where you can be reached”, and the caller will then be given a predetermined period of time in which to enter the “callback” number. This greeting is preferably permanent, and cannot be personalized, changed, or altered by the service subscriber. Preferably, upon completion of entry of the “callback” number by the caller, an acknowledgment is generated, which can acknowledge that the “callback” number was properly entered, the dual-tone, multi-frequency signals were properly converted into a short message service text message, the numeric-only page was successfully transmitted, or all of the foregoing. This acknowledgment could take one of many forms, but is preferably a simple confirmation tone, which might or might not be preceded by an acknowledgment from the auto-attendant. Those skilled in the art will appreciate that the acknowledgment will vary depending upon the capabilities and resources of the voice mail platform and the flexibility of the vendor when creating the preferred class of service.

A second characteristic of this new class of service is that it preferably does not permit voice message capability. In particular, unlike standard voice mailboxes, the mailbox for this class of service preferably will not offer the caller the option to leave a voice message. The mailbox simply will register and interpret the DTMF tones generated for the “callback” number and deliver the appropriate acknowledgment to the caller.

A third characteristic of this new class of service is that it preferably has no message limits. In particular, the maximum limits should be set on all parameters for voice storage and message limits. No voice message storage is contemplated, so relatively little memory will be required. In effect, the voice mailbox serves as a pass-through account only.

A fourth characteristic of this new class of service is that it preferably has the SMS port enabled. As illustrated in the drawing, once the DTMF tones are received and interpreted, the short message text is derived and delivered to the SMS server. The SMS port must be enabled to permit delivery of this numeric page to the SMS server.

A fifth characteristic of this new class of service is that its mailbox is preferably separate from a mailbox created for standard voice mail service. Preferably, if a subscriber also has standard voice mail, which will often be the case, the subscriber will preferably have two separate accounts established. As will be appreciated, the main telephone number could be associated with the standard voice mail service, whereas the auxiliary telephone number could be associated with the numeric-only paging service of the present invention. As will be appreciated, the present invention is exclusive of standard voice mail service. The present invention can be offered as a stand-alone service, it can be processed through a voice mail system entirely separate from a system providing standard voice mail service, it can be implemented (preferably separately) with a voice mail system that also provides standard voice mail service.

As will be appreciated by those skilled in the art, voice mail system 16 illustrated in FIG. 1 and described above could be replaced by a paging terminal interface of the type readily available for use. It is contemplated that such a paging terminal interface would perform some of the same functions as voice mail system 16, namely translation of the DTMF tones, conversion of those tones to text and transmission of the text message to SMS server 18. It will be appreciated, however, that use of a paging terminal interface in lieu of voice mail system 16 would be generally much more expensive. In particular, use of a voice mail system makes more practical sense, considering most wireless telephone users already subscribe to standard voice mail service and their voice mail system would therefore need merely be re-configured, preferably as described above. Additionally, since the voice mail system is typically already in place, it is already generating revenue for the wireless telephone service provider. For purposes of this specification, including the following claims, both a paging terminal interface unit and a voice mail system, such as voice mail system 16, shall fall within the scope of the phrases “dual-tone, multi-frequency-to-short message service converter” and “DTMF-to-SMS converter”. It will be appreciated, however, that the phrases “dual-tone, multi-frequency-to-short message service converter” and “DTMF-to-SMS converter” shall also encompass a device that performs such conversion.

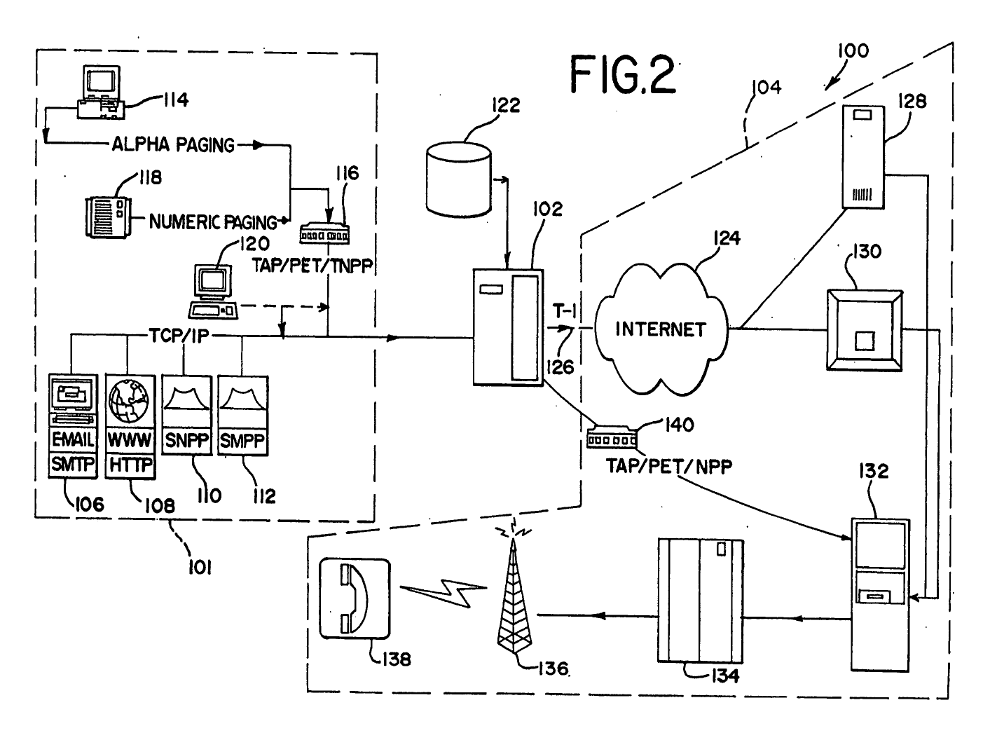

FIG. 2 illustrates a communications system generally designated 100 designed to maintain the privacy of a main telephone number associated with a cellular telephone or a main pager number assigned to a page receiving device, while providing transmission of alphanumeric messages to the telephone or pager. It will be appreciated by those skilled in the art that communications system 100 illustrated in FIG. 2 can be used in conjunction with communicating system 10 illustrated in FIG. 1. The system is shown as being for use in conjunction with a wide range of alphanumeric messaging applications. Incorporating the principles of communications system 100 allows an auxiliary telephone number to become a wireless telephone or pager subscriber's universal contact number.

To facilitate understanding, communications system 100 can be characterized as including a plurality of inputs grouped together and identified by reference numeral 101, an auxiliary-to-main telephone/pager number translation device 102 referred to as a privacy page server, and a plurality of outputs grouped together and identified by reference numeral 104.

Translation device 102 can accept any of the TCP/IP protocols over the internet or any equivalent computer network. Of the available TCP/IP protocols, SMTP, HTTP, SNPP and SMPP are illustrated in FIG. 2. In particular, SMTP protocol is illustrated as block 106 and is known to be suitable for Email utility applications; HTTP protocol is illustrated as block 108 and is known to be suitable for world wide web messaging applications; and SNPP and SMPP protocols are illustrated as blocks 110 and 112, respectively, and are known to be suitable for pager notification applications.

In addition, translation device 102 can accept any of the direct dial-up connection protocols, including TAP, PET and TNPP protocols. A direct dial-up paging device 114 is illustrated as being connected to translation device 102 through a modem pool generally designated 116. Similarly, a voice mail platform unit 118 is illustrated as being connected to translation device 102 through modem pool 116. Paging device 114 and voice mail platform unit 118 both operate preferably in accordance with an available direct dial-up connection protocol.

In addition to the foregoing inputs 101, an answering service 120 can also be provided. As will be appreciated by those skilled in the art, answering service 120 can operate in accordance with any of the available protocols, including any of the full suite of TCP/IP protocols and any of the direct dial-up connection protocols.

Translation device 102 receives as input an alphanumeric message formatted in one of the aforementioned protocols. The transmitted alphanumeric message includes data associated therewith indicative of the auxiliary telephone number of the wireless telephone service subscriber or the auxiliary pager number of the pager subscriber. Translation device 102 translates the auxiliary telephone number to the main telephone number of the wireless telephone service subscriber (or translates the auxiliary pager number to the main pager number of the pager subscriber), and can use a translation table 122 for this purpose.

For present purposes, when the applications herein are described as being for use in conjunction with wireless telephone service, it will be understood that it is the intention that they also be considered for use in conjunction with alphanumeric paging service. Therefore, for present purposes, a description of one use shall suffice as a description of the other. For wireless telephone service, the subscriber is assigned an auxiliary telephone number and a main telephone number, which activates calls to the handset. For alphanumeric paging service, the subscriber is assigned an auxiliary pager number and a main pager number, which permits pages to be transmitted to the page receiving device.

Referring back to FIG. 2, for outputs 104, translation device 102 can be in communication with the internet 124, preferably through a T-1 line 126. Through the internet 124, the message is preferably routed to either an email server 128, operating in accordance with STMP protocol, or a web server 130, operating in accordance with HTTP protocol, both of which will be maintained ordinarily by the wireless carrier. It will be appreciated that other ones of the TCP/IP protocols could be available and used to route the message.

From servers 128, 130, the message is routed to an SMS server 132 wherein the message is converted into a short message service text message. SMS server 132 then transmits a paging signal to a mobile telephone switching office (MTSO) 134 for message delivery. The SMS server 132 is preferably connected to MTSO 134 through either a dial-up connection or a serial link. Once paged, MTSO 134 locates the digital telephone subscriber based upon the nearest cell site 136 to digital wireless handset 138 or a page receiving device (not shown), and thereafter delivers the short message service text message to the telephone or page receiver.

Alternatively, and in lieu of being routed to either of servers 128, 130, the message can be routed directly to SMS server 132. Under such circumstances, the translation device 102 will preferably have a direct dial-up connection with SMS server 132 and the message will be routed through a modem pool 140 to the SMS server in accordance with a suitable protocol, such as TAP, PET or TNPP. At SMS server 132, the message is converted to a short message service text message and ultimately routed to digital wireless handset 138, as described above.

Various applications, using a variety of protocols, are available for use with the communications system 100 illustrated in FIG. 2. Five such applications are described below.

A first such application is electronic mail (Email) communication. As will be appreciated by those skilled in the art, Email communication is an internet application that utilizes SMTP protocol. Digital wireless carriers often offer Email service to their digital wireless subscribers, assigning an email address to a subscriber's handset. Conventionally, the address includes the subscriber's main telephone number as part of the Email address. For example, the Email address typically is formatted as shown below:

xxx-xxx-xxxx@domain.com/net/org/edu

where the x's represent the respective digits of a subscriber's main telephone number for receiving incoming calls.

With the present invention, it is possible to assign an auxiliary telephone number in lieu of the main telephone number as a portion of the Email address for the digital wireless subscriber. As a result, the message contained within the Email can be routed to the wireless handset without the use of the primary mobile number as part of the Email address.

Using a phantom, auxiliary telephone number for part of an Email address and translating the phantom Email address into the subscriber's true Email address, which conventionally includes the main telephone number as a part thereof, allows the auxiliary telephone number to become a subscriber's universal contact number. In this and the other applications, a translation device, such as translation device 102 illustrated in FIG. 2, can also be incorporated within the server illustrated in FIG. 1 that converts DTMF tones into text. It will be appreciated that the phantom Email address (i.e., that which includes the auxiliary telephone number as a part thereof, and does not include the main telephone number as a part thereof) will be directed or translated to the subscriber's Email address, which can be assigned to a computer, the subscriber's handset, or to any other Email-receiving device.

Referring to FIG. 2, the Email message addressed to the phantom Email address is routed in accordance with SMTP protocol 106 to translation device 102. At translation device 102, translation occurs, and the Email message is re-routed over the internet 124 to Email server 128, operated by the wireless carrier. The message is then routed to SMS server 132 and ultimately to the Email-receiving device, which in the illustrated case is the digital wireless handset 138 of the digital subscriber. At handset 138, a short message service text message is received corresponding to the message sent in the delivered Email.

A second application is general web based messaging (i.e., other than Email communication). As will be appreciated by those skilled in the art, this form of web based messaging is an internet application that utilizes HTTP protocol. Digital wireless carriers often offer such web based messaging service to their digital wireless subscribers by maintaining and providing short text messaging ability through a worldwide website. Conventionally, the websites allow anyone with access to the worldwide web (via a web browser, for instance) to transmit a text message directly to a subscriber's digital wireless handset by identifying the subscriber's main telephone number. The website servers are ordinarily connected to the wireless carrier's short message server.

Upon downloading a webpage from the carrier's web server, a paging party typically completes fields before causing delivery of the alphanumeric message to the wireless subscriber's digital handset. Among perhaps others, the fields typically include one corresponding to the alphanumeric body of the message, and another corresponding to the subscriber's main telephone number. As will be appreciated, the former field is required to identify what message is to be delivered, and the latter field is required to identify where that message is to be delivered. Once the fields are completed, and a message delivery request is received at the carrier's web server, the message is routed to the carrier's SMS server and then ultimately to the subscriber's digital wireless handset as a short message service text message.

In accordance with the principles of the present invention, the wireless subscriber can utilize an auxiliary telephone number as the contact number for web based messaging. In particular, an auxiliary telephone number is input into the latter field described above in lieu of the main telephone number. As a result, the message can be routed to the wireless handset while maintaining the privacy of the primary mobile number.

Using a phantom, auxiliary telephone number and translating it into the subscriber's main telephone number for delivery to the handset allows the auxiliary telephone number to become a subscriber's universal contact number. A translation device, such as translation device 102 illustrated in FIG. 2, can translate the auxiliary telephone number by substituting the main telephone number for the auxiliary telephone number in the appropriate field, and then delivering the message to the wireless subscriber in accordance with prior practices. As will be appreciated, the text message can be routed to the subscriber's Email address, which can be assigned to a computer, the subscriber's handset (as shown in FIG. 2), or to any other Email-receiving device.

Referring to FIG. 2, the web based message with the auxiliary telephone number is routed to translation device 102 in accordance with HTTP protocol 108. At translation device 102, translation occurs, and the message is re-routed over the internet 124 to web server 130, operated by the wireless carrier. The message is then routed to SMS server 132 and ultimately to the Email-receiving device, which in the illustrated case is the digital wireless handset 138 of the digital subscriber. At handset 138, a short message service text message is received corresponding to the alphanumeric text inserted into the message body field.

A third application is voice mail message or pager notification. As will be appreciated by those skilled in the art, this form of communication generally notifies a voice mail subscriber that a new message awaits in the mailbox assigned to that subscriber. As will be appreciated by those skilled in the art, this application can utilize SMPP and SNPP protocols, among others.

In this application, a voice mail platform is conventionally caused to dial out to a pager, which notifies the subscriber of the newly received message. Upon such notification, the subscriber knows to check his/her messages in his/her voice mailbox.

In accordance with the principles of the present invention, the wireless subscriber can utilize an auxiliary telephone number as the contact number for all voice mail message or pager notification. In particular, in the event that notification takes place, the voice mail platform can dial out to the auxiliary telephone number, which is thereafter translated to the main telephone number, or alternatively a main pager number assigned to an alphanumeric pager, and then routed to the digital handset or pager of the subscriber. As a result, the notification can be routed to the wireless handset or pager while maintaining the privacy of the main telephone number and/or main pager number.

Using a phantom, auxiliary telephone number (or auxiliary pager number) and translating it into the subscriber's main telephone number (or the subscriber's main pager number) for delivery allows the auxiliary number to become a subscriber's universal contact number. A translation device, such as translation device 102 illustrated in FIG. 2, can translate the auxiliary telephone number into the main telephone number. Thereafter, the message or pager notification is delivered to the handset or pager of the wireless subscriber in accordance with prior practices.

Referring to FIG. 2, a voice mail platform (not shown) dials out a notification signal to the auxiliary telephone number. As a result, the notification signal is routed to translation device 102 in accordance with SNPP protocol 110 or SMPP protocol 112. At translation device 102, translation occurs, and the notification signal is set to be delivered to digital handset 138 of the subscriber. From translation device 102, the notification signal is routed to SMS server 132, either directly or through the internet 124. From SMS server 132, the notification signal is ultimately routed to digital wireless handset 138 of the wireless subscriber and the subscriber is thereby notified that a new message awaits in his/her voice mailbox.

In an alternative arrangement of voice mail message or pager notification, and still referring to FIG. 2, voice mail platform unit 118 dials out a notification signal using the auxiliary telephone number. In this case, voice mail platform unit 118 dials out to translation device 102 and connects thereto via a direct dial-up connection. Specifically, the notification signal is transmitted through modem pool 116 en route to translation device 102. The notification signal is routed to translation device 102 in accordance with a suitable direct dial-up connection protocol, such as TAP, PET or TNPP. Outside of the foregoing, this arrangement functions similar to that described above.

A fourth application is traditional alphanumeric paging service. As will be appreciated by those skilled in the art, this application typically utilizes an available direct dial-up connection protocol, such as TAP, PET or TNPP. As will also be appreciated by those skilled in the art, this application is conventionally offered by an alphanumeric paging service provider, which utilizes a proprietary paging terminal and a modem pool to deliver alphanumeric pages to a subscriber. A keypad device designed for inputting and sending alphanumeric paging text messages, or easy to install computer software for home, small business, or network-based use, are the primary options for formulating and delivering alphanumeric text messages using the above protocols. Conventionally, the message is sent to the digital handset or the pager of a wireless subscriber by inputting either the main telephone number assigned to the handset or the main pager number assigned to the pager.

In accordance with the principles of the present invention, the wireless subscriber can utilize an auxiliary telephone number as the contact number for all alphanumeric paging applications. In particular, in the event that an alphanumeric page is sent to the subscriber's auxiliary telephone number, it can thereafter be translated to the subscriber's main telephone number and then routed to the digital handset of the subscriber. Alternatively, in the event that an alphanumeric page is sent to the subscriber's auxiliary pager number, it can thereafter be translated to the subscriber's main pager number and then routed to the page receiver of the subscriber. As a result, the alphanumeric page can be routed to the subscriber's wireless handset or pager while maintaining the privacy of the respective main number.

Using a phantom, auxiliary telephone number (or auxiliary pager number) and translating it into the subscriber's main telephone number (or translating it into the subscriber's main pager number) for delivery allows the auxiliary number to become a subscriber's universal contact number. A translation device, such as translation device 102 illustrated in FIG. 2, can translate the auxiliary telephone number into the main telephone number. Thereafter, the alphanumeric page is delivered to the handset or pager of the wireless subscriber in accordance with prior practices.

Referring to FIG. 2, direct dial-up paging device 114 dials out an alphanumeric page to the auxiliary telephone number. As implied above, paging device 114 can be a keypad device specifically designed to formulate and send alphanumeric pages, or can be a computer programmed with software allowing such capability. The alphanumeric page, addressed to the auxiliary telephone number, is routed to translation device 102 through modem pool 116 in accordance with a suitable direct dial-up protocol, such as TAP, PET or TNPP. At translation device 102, translation occurs, and the alphanumeric page is re-routed to digital handset 138 of the subscriber. In particular, from translation device 102, the alphanumeric page is routed to SMS server 132, either directly or through the internet 124. From SMS server 132, the alphanumeric page is ultimately routed to digital wireless handset 138 of the wireless subscriber and the subscriber is thereby provided with a short text message corresponding to the alphanumeric page.

A fifth application is operator transcription service. As will be appreciated by those skilled in the art, many digital wireless subscribers and alphanumeric paging subscribers utilize the services of operator transcription, which is also known in the art as an answering service. In this environment, an operator takes telephone calls and messages on behalf of the subscriber, and forwards messages to the subscriber based on the preferences indicated by the subscriber. Available options include message delivery via any of the available communication protocols, including both internet and direct dial-up communication protocols (e.g., SMTP, HTTP, SMPP, SNPP, TAP, PET, TNPP and DTMF).

As indicated above, the translation device can perform its functions regardless of the format of the message. Therefore, an auxiliary number, rather than a main number, can be provided to the operator transcription services provider. The provider can then be instructed as to the preferred message delivery method of the subscriber.

Referring to FIG. 2, answering service 120 is connected to translation device 102, and permits communication therewith under any of the available TCP/IP internet protocols and any of the available direct dial-up protocols. Upon receipt of a message to be forwarded to the subscriber, an operator at answering service 120 delivers the message to the auxiliary number in the subscriber's preferred form of delivery. The message is then routed to translation device 102, where the auxiliary number is translated into the main telephone number or the main pager number of the subscriber. In response, the message is re-routed to the subscriber's digital handset 138 or alphanumeric pager, and delivered in its preferred form. Again, the privacy of the main telephone number and main pager number of the subscriber is maintained.

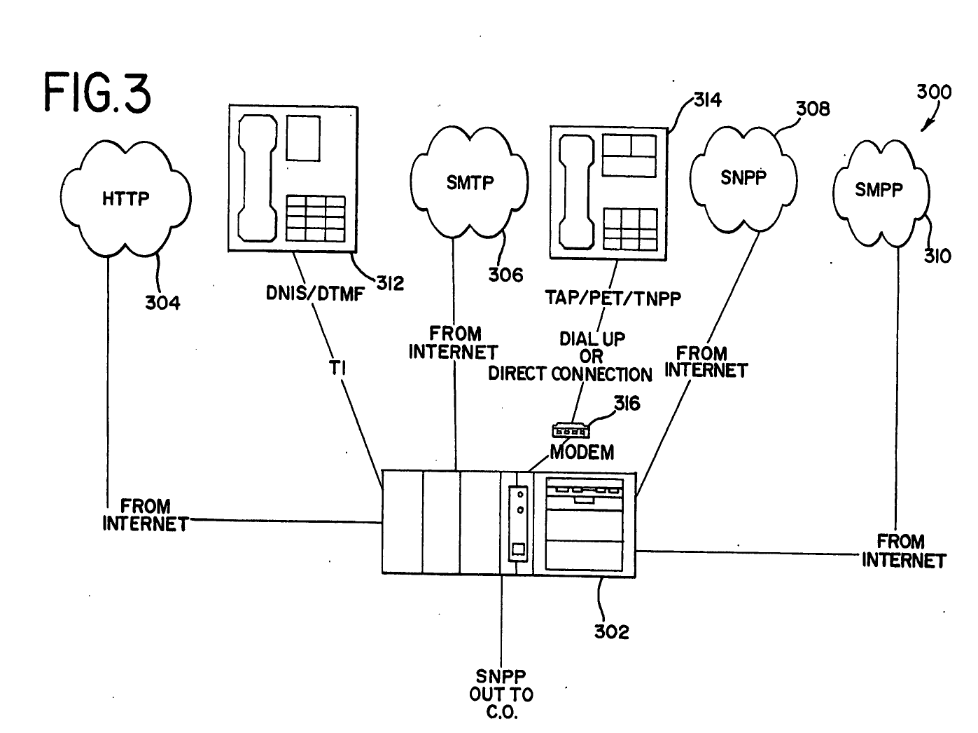

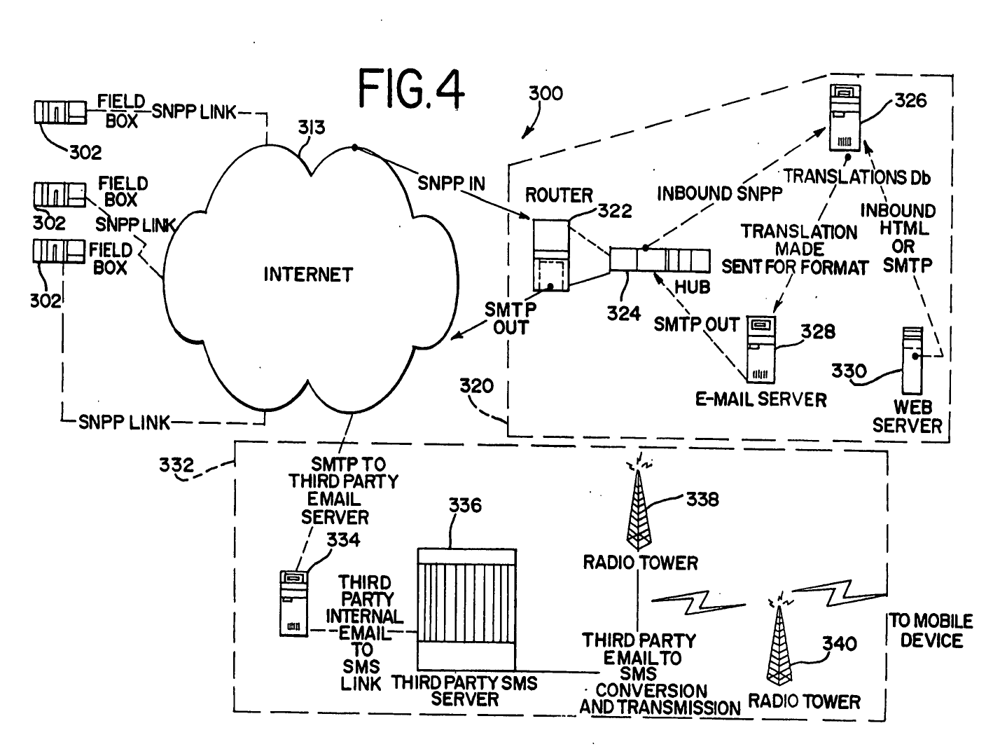

FIGS. 3 and 4 illustrate a communications system 300 utilizing the privacy features of the present invention. FIG. 3 is directed to the input devices for the system and a field box that receives input data corresponding to message and address information, and transfers the data to the privacy number service provider. As shown in FIG. 3, communications system 300 includes a field box 302 linked to a plurality of input devices. Among others, several TCP/IP communication protocols can be received by field box 302, including HTTP communication protocol 304, SMTP communication protocol 306, SNPP communication protocol 308, and SMPP communication protocol 310. As will be appreciated, HTTP communication protocol 304 can be utilized to provide web-based messaging service, SMTP communication protocol 306 can be utilized to provide e-mail messaging service, SNPP communication protocol 308 can be utilized to provide voice mail message or pager notification service, and SMPP communication protocol 310 can also be utilized to provide voice mail message or pager notification service.

In addition to the foregoing, a DTMF keypad, such as the landline telephone 312 illustrated in FIG. 3, is linked to field box 302, preferably by way of a T1 communication link. As such, field box 302 is designed to receive data formatted in accordance with DNIS and DTMF communication protocols.

In addition, a direct dial-up paging device, such as the landline telephone 314 illustrated in FIG. 3, is linked to field box 302 through a modem device 316. As such, field box 302 is designed to received data formatted in accordance with any available direct dial-up communication protocol, including TAP, PET and TNPP communication protocols. As shown in FIG. 3, field box 302 is preferably linked to a central office and delivers the message in accordance with SNPP communication protocol.

FIG. 4. illustrates a plurality of field boxes 302 linked through the internet 318 to the central office 320 of a privacy number service provider. As specified above, communication with central office 320 is preferably in accordance with SNPP communication protocol. Central office 320 preferably includes a router 322 to receive messages from and deliver messages to the internet 318, a hub 324 linked to router 322, a number translation server 326 linked to hub 324, an e-mail server 328 also linked to hub 324, and a web server 330 linked to number translation server 326. As will be appreciated by those skilled in the art, the hardware included within central office 320 could all reside in a single unit. The respective functions performed by each of those devices is discussed below.

FIG. 4 also illustrates hardware typically under the control of the wireless carrier and generally grouped together under reference numeral 332. Within group 332, there is preferably included an e-mail server 334 linked to the internet 318, an SMS server 336 linked to e-mail server 334, and a carrier radio tower 338 and cell site radio tower 340 to deliver messages to a mobile device (not shown), such as a digital wireless handset and/or a page receiving device.

In operation, and referring to FIG. 3, field box 302 receives data corresponding to message information and address information. The address information is in the form of an auxiliary telephone or pager number. As explained above with reference to the communications systems depicted in FIGS. 1 and 2, use of the auxiliary number allows the wireless subscriber to maintain the privacy of the main number associated with the subscriber's wireless (mobile) device.

As shown in FIG. 3, field box 302 can receive the above-identified information in accordance with a variety of communication protocols, all of which were discussed with reference to FIGS. 1 and 2.

Referring to FIG. 4, the respective field box 302 communicates over the internet 318 in accordance with SNPP communication protocol and delivers packets containing the message and address information to router 322. From router 322, such packets are delivered through hub 324 to translation server 326. At translation server 326, translation occurs, and the address information is converted to correspond to the main number of the wireless device, which will preferably be included within an e-mail address associated with that device.

After such translation, the communication is delivered to e-mail server 328 to format the message and address information in accordance with SMTP communication protocol. In particular, the message will be delivered to an e-mail address associated with the wireless device used by the privacy number subscriber.

From e-mail server 328, the SMTP e-mail message is delivered through hub 24 and router 322 over the internet 318 to an e-mail server 334 conventionally operated by the wireless carrier. From e-mail server 334, the message is delivered to short message service server 336 to convert the e-mail message into an appropriate short message service text message that can be displayed by a wireless device.

The short message service text message is then delivered to carrier radio tower 338 and transmitted as a radio frequency signal to cell site radio tower 340 and ultimately to the mobile device (not shown), which can be a digital wireless handset and/or a page receiving device, among other things.

With regard to web-based messaging, such messaging can be provided for by the privacy number service provider at web server 330. In particular, when data is input into the message body and address fields and a send command is received, the message and address information is delivered to translation server 326, which converts the address information from data corresponding to the auxiliary number to data corresponding to the main number. This delivery from web server 330 to translation server 326 is in accordance with either HTML (web-based) communication protocol or SMTP (email) communication protocol. Delivery of the message to the mobile device then continues as detailed above.

Alternatively, or in addition to the foregoing, a web server can be located elsewhere as shown by HTTP protocol 304 in FIG. 3. Under these circumstances, a field box receives web-based messaging over the internet in accordance with HTTP communication protocol 304. Delivery of the message to the mobile device continues as set forth above.

While the communication systems illustrated in the drawings each have a particular network configuration, it will be appreciated by those skilled in the art that other network configurations could be used, including, among others, a token-ring network configuration.

While this invention has been described with reference to preferred aspects of the present invention, it will be understood that this description shall not be construed in a limiting sense. Rather, various changes and modifications can be made to the preferred aspects of this invention without departing from the true spirit and scope of the invention, as defined by the following claims. Furthermore, it will be appreciated that any such changes and modifications would be recognized by those skilled in the art as an equivalent to one element or more of the following claims, and shall be covered by such claims to the fullest extent permitted by law.

1. A method of delivering a message to a wireless device, comprising the steps of:
associating a first number with the device, the first number included within a true address for communication with the device;
associating a second number with the device, the second number being distinct from the first number and not being included within said true address;
receiving a communication that includes a phantom address and a message, at least a portion of said phantom address including the second number;
deriving the true address by at least deriving the first number from the second number; and
delivering the message to the device based upon the derived true address.
